(19) United States
(12) Patent Application Publication
(10) Pub. No.: US 2002/0138482 A1
(43) Pub. Date: Sep. 26, 2002

(54) Process for nonlinear processing and identification of information

(76) Inventors: Alexander Beeck, Orlando, FL (US); Rolf Dittmann, Nussbaumen (CH); Reinhard Fried, Nussbaumen (CH)

Correspondence Address: Robert S. Swecker, BURNS, DOANE, SWECKER & MATHIS, L.L.P., P.O. Box 1404, Alexandria, VA, 22313-1404, US

(21) Appl. No.: 10/012,304

(22) Filed: Dec. 12, 2001

(30) Foreign Application Priority Data
Dec. 23, 2000 (EP) 00128470.2

(51) Int. Cl. G06F 7/00

(52) U.S. Cl. 707/7; 707/1

(57) ABSTRACT

In a method of processing and identification of information, documents are processed in the form of hierarchically structured information units. Characteristic graphic elements are in particular shown in an overview representation. In this manner, the information content of a document can be grasped more rapidly and more accurately than by keyword searches.

### FIELD OF THE INVENTION

The present invention relates to a process for the nonlinear processing and identification of information.

### DESCRIPTION OF PRIOR ART

The generation of information which is usable in business, technology and science has immensely increased in the last decades. The evaluation and utilization of this wealth of information means, particularly in business life, an immense competitive advantage.

Nearly every kind of information is today accessible in any manner in collected and indexed form. The archiving of documents in paper form with indices, for example in card form, and in the form of microfiches, has today been almost completely displaced to electronic databases. The documents are frequently available in full text searchable form. Where knowledge was earlier collected in a few large libraries, today nearly every state of knowledge is easily and rapidly accessible at nearly any place to a nearly arbitrarily large circle of persons.

General accessibility of large amounts of information to a large circle of users is a given. The problem which is raised by a search today is in fact also to actually select the relevant information from the wealth of available information. For this purpose, documents and other information are indexed and classified, for example, according to subject matter ranges, keywords, author, publication date, IPC classification in the case of patents, and numerous further criteria. At the same time, computer databases make powerful search tools available, and frequently documents are full text searchable, which means that the whole information content of a document can be searched according to given concepts.

Thus it has become remarkably simple to search through a large wealth of information according to optional proper keywords and bibliographic data. As a result of such a search by individual keywords and also within limited subject matter ranges—in most cases an unmanageably large amount of data is obtained. The search must also be restricted by the linking together of keywords. The possibilities of boolean algebra are available for this purpose. According to their nature, however, these are linear operations, which are applied to nonlinear problems—namely, the semantics and the verbal description of a state of affairs. The discovered documents are then analyzed according to their information content and categorized as relevant or not relevant. The selection using linear operations is thus necessarily followed by a nonlinear operation, namely the grasping of the information content proper in the whole verbal context of a document. Besides the problem of restricting the search, on the other hand the problem arises of searching according to synonyms. By this is meant not only the problem of synonyms or isolated concepts, but also the problem of synonymous descriptions of combinations of features.

The said difficulties also persist when a preselection has already been made by an indexing or classification of documents and association according to given subject matter ranges.

A number of database providers offer their own brief abstracts of documents. The step of the analysis of information content is thereby really already carried out. Likewise, these brief abstracts have to be again searched according to keywords and combinations of keywords, with the abovementioned problems of sufficient restriction on the one hand, and the inclusion of synonyms on the other hand. In addition, the writer of such a brief abstract can classify a document in a completely different context than a specific searcher would.

According to the state of affairs, the search for relevant information also has the problem of, on the one hand, restricting the search to specific subject matter content, and on the other hand to make the search wide enough in order also to include synonyms of any kind. Although powerful search tools are available, the principal weakness remains that the nonlinear nature of the task, of seeking the verbal paraphrase of a fact, is solved with linear methods.

### SUMMARY OF THE INVENTION

The invention will provide a remedy here. The invention has as its object to provide a method for processing and identification of information, with which the relevant information content can be rapidly and accurately determined without the expensive reading of a document.

This object is attained by the features of claim 1.

In its core, the invention makes use of the knowledge that technical and scientific facts are frequently to be shown in the form of a drawing or diagram, on the one hand more concisely than in a verbal description, and on the other hand can be assimilated substantially more rapidly by human understanding in this form. This is also apparent from the fact that readers, particularly of technical literature, mostly make a first choice using drawings and graphic representations, before they read the thus selected documents. The invention is of course not the identification of the information itself, but the processing of the information in a manner such that it can be quickly grasped and is accessible in different depths of information.

In a preferred embodiment of the invention, only the uppermost information unit of any document is shown on a representation of the greatest information width. This is quite particularly advantageously a figure or a concise excerpt from a figure, which of course is quite particularly suitable for processing and representation of constructive facts.

It is, furthermore useful if documents are allocated to given subject volumes. This permits the user to already find a preselection.

References to continuing documents which can also be located outside the specific document stock are advantageously inserted into at least one representation of the greatest information depth.

The method can be quite particularly advantageously implemented on a computer system or in a computer network, each document being stored as a data set in a database. Such an implementation preferably also includes the graphic user interface (GUI) by means of which a user can navigate through the different information planes.

Summarizing, the invention is based on the idea of first analyzing information and processing it according to specific interest profiles, well accessible, in particular optically, to human awareness. This information, of high overall information content, is then filed in data sets, particularly suitably in data sets in a computer database, but in principle in another manner. The representation of the information is chosen so that this is shown in different levels of detail, so that easily accessible and rapidly assimilable information is depicted with a low information depth but a high information width. This is the overview representation. From there on, the user can easily select information of potential interest, and if required can branch into greater information depth.

### BRIEF DESCRIPTION OF THE DRAWING

The invention is explained in detail hereinafter with reference to the accompanying drawing. The figures show, by way of example, some modes of representation of documents prepared according to the invention.

### DESCRIPTION OF PREFERRED EMBODIMENTS

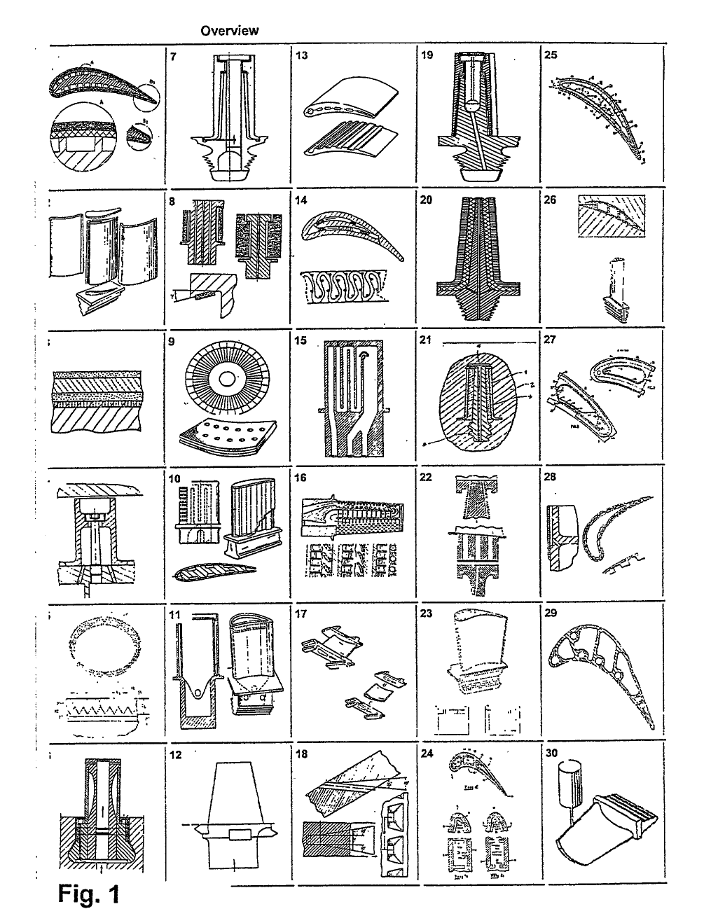

In FIG. 1, an example in principle is given of a representation of documents at the highest information width. In principle this is an overview representation. A collection of documents is concerned, which are for example connected under the subject matter of “gas turbine blades.” A respective drawing is selected as the uppermost information unit, which highlights characteristic features of a given document which are relevant in the specific connection. Such a representation alone can already serve as an “aid to inspiration” for a design engineer. In the embodiment of the invention with a computer system, a reference to another level of detail can be hidden in the background of each Figure within this overview representation, and can be selected with a mouse click, for example.

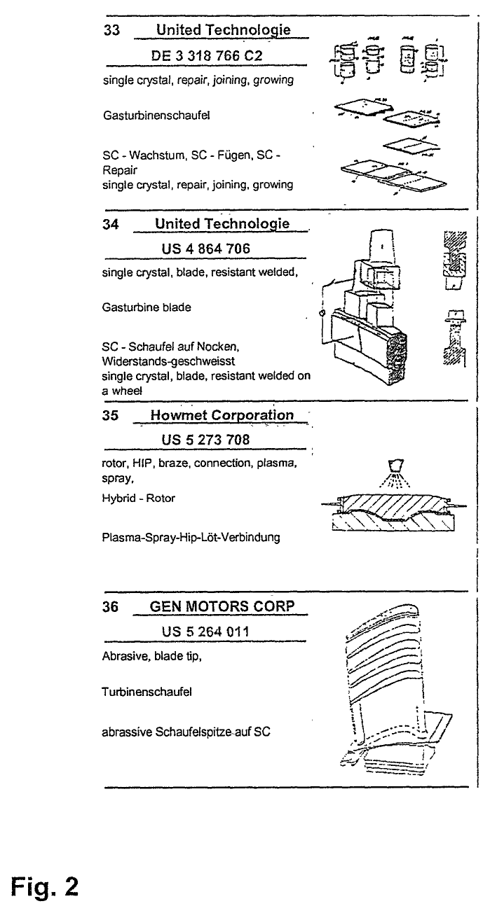

In the representation of FIG. 2, documents are shown on a representation of greater information depth. Here patent documents are concerned, since the patent literature today forms an important and freely accessible resource for the state of the art. In this level of detail there are given, in addition to the relevant known figure in the specific context, furthermore also the patentee and the publication number as bibliographic data, and also a number of relevant keywords.

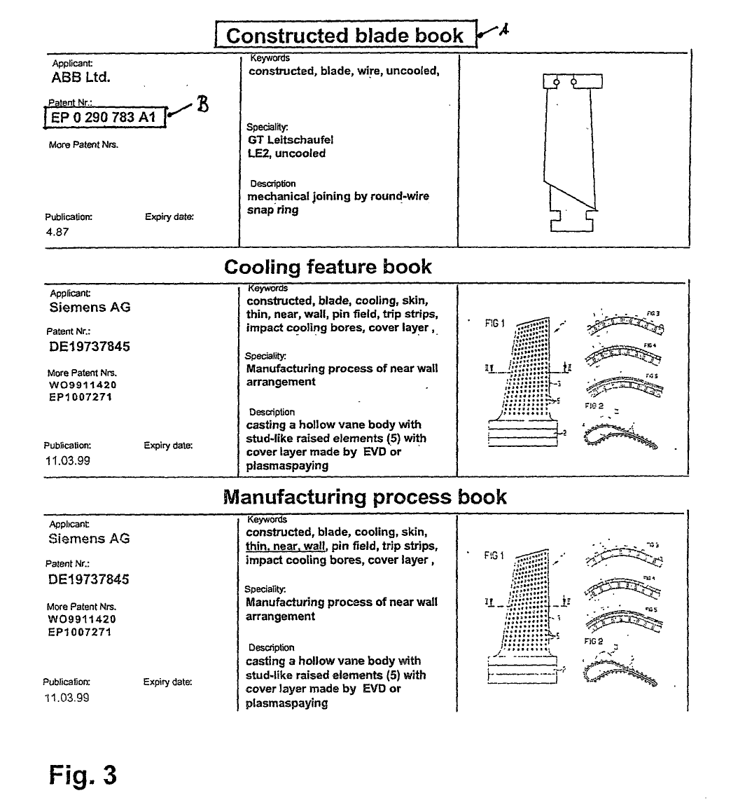

From the representation in FIG. 2, branching can furthermore take place, by the selection of documents with a pointing instrument such as a mouse, to a further representation, shown by way of example in FIG. 3. Further content and bibliographic details are given here. In particular, the allocation of a document to a subject volume (detail A) is given here. The patent number is provided with a reference to a full text document. This can in principle be a reference to a data file, but can also be a so-called hyperlink, which refers to an internet address where the full text document is archived and loads this onto the local computer system.

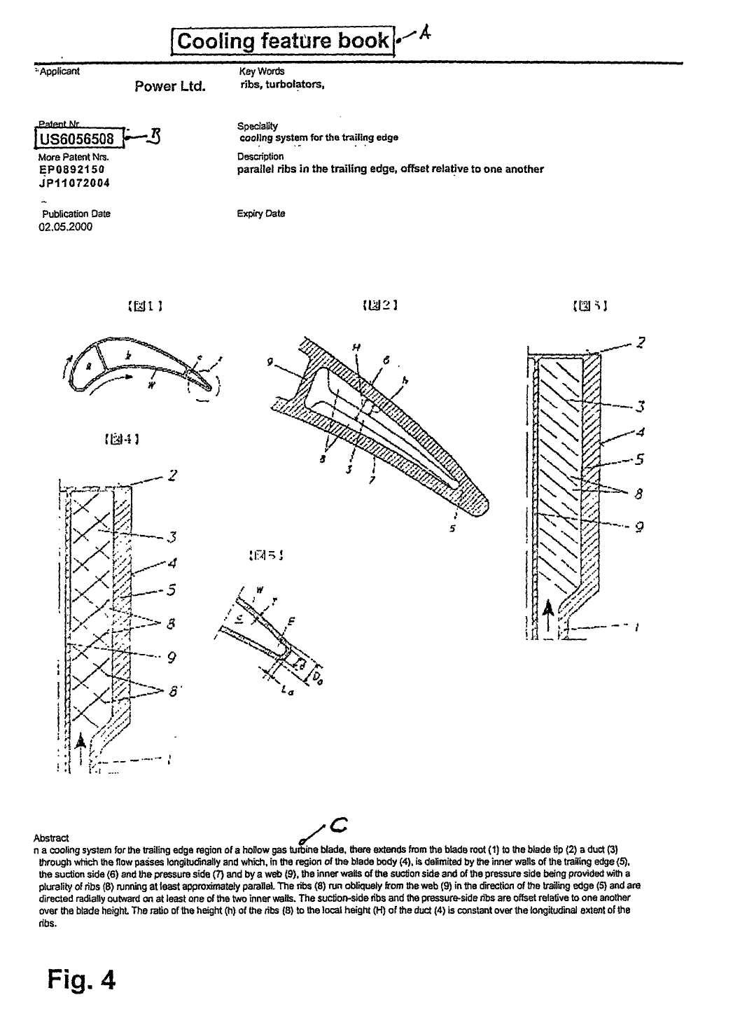

Finally, FIG. 4 only shows one more document, but in a representation having the greatest information depth. This representation contains further Figures and also a brief abstract (Detail C). Also here the full text document is directly accessible under the document number B.

The display of the documents can take place sorted according to subject volumes or according to other criteria. In FIG. 3, documents are shown from the subject volumes “Constructed Blade Book,” “Cooling Feature Book” and “Manufacturing Process Book.” It is advantageous to give the user the possibility, for a first restriction of the amount of documents, of selecting given subject volumes for display. Furthermore it is also to be recognized that a document can throughout be also allocated to several subject volumes.

The processing of the data for representation in the form shown here demands a single analysis of the document. Furthermore the classification into a specific interest profile takes place, in particular the allocation to a subject volume. The identification and optical emphasis and/or processing of an information unit occurs as the uppermost information unit. In the case shown in the embodiment example, a relevant figure or a relevant excerpt from a figure is categorized as the uppermost information unit. The information content of the document is divided into differently weighted information units, which are arranged in different hierarchy levels. The thus processed document is filed in a document stock. In particular, in the implementation of the invention there is the possibility of filing the information units of each document as a data set in a database. Thus it is also possible to insert references into the documents to full text documentation or to continuing documents. These can quite particularly be so-called hyperlinks and other addresses in a worldwide computer network. In particular in the detail stages, which are shown in the example in FIGS. 2-4, a document filed in another database, on another data carrier, or on another computer, for example even in another data format, can be called up by selecting the document number by means of a pointing instrument. Here different data sets from different kinds and formats of documents, which are filed on different computers, can also be called up.

The special feature of the method according to the invention is primarily that the search through the documents does not primarily take place by means of linear operations—the linking of search concepts by means of operators of boolean algebra—but the information is processed so that the relevance of the document is determined using optical and intellectual analysis of the uppermost information unit: in the example, the drawing.

Patent claims

1. Method of non-linear processing and identification of information, which method includes the following steps:
analysis of a document;
arranging the document in order in a specific interest profile;
identification of a relevant information unit as the uppermost information unit;
optical emphasis and/or processing of the uppermost information unit;
subdivision of the document into differently weighted information units;
arranging in order the weighted information units of the document in an arrangement scheme for information units;
arranging the documents in order in a document stock;
representation of equally weighted information units of different documents of the document stock in an overview representation of a first level of detail with a first information width and a first information depth;
insertion of a reference to at least one representation of a second level of detail with smaller information width and greater information depth.

2. Method according to claim 1, wherein only the uppermost information of the documents of the document stock is depicted in a representation of the least information depth and the greatest information width.

3. Method according to one of claims 1 or 2, wherein the uppermost information unit is a Figure or a concise excerpt from a Figure according to the specific interest profile.

4. Method according to one of claims 1-3, wherein documents of the document stock are allocated to given subject volumes.

5. Method according to one of claims 1-4, wherein references to continuing documents are inserted at least into a representation of the greatest information depth.

6. Method according to one of claims 1-5, wherein the method is carried out by means of a program on a computer and/or on a networked computer system.

7. Method according to claim 6, wherein each document is stored as a data set in a database.

8. Computer database, which contains documents processed according to a method according to one of claims 1-7.

9. Computer database according to claim 8, which contains automated reference to documents which are filed in other databases and/or on other computers.

10. Computer readable data carrier on which a computer database according to one of claims 8 or 9 is stored.
